(19) United States
(12) Patent Application Publication
(10) Pub. No.: US 2025/0337337 A1
(43) Pub. Date: Oct. 30, 2025

(54) POWER REGENERATION CONVERTER

(71) Applicant: Hitachi Industrial Equipment Systems Co., Ltd., Tokyo (JP)

(72) Inventors: Susumu ORUI, Tokyo (JP); Masayuki WATANABE, Narashino-shi (JP); Shunsuke MATSUNAGA, Tokyo (JP)

(73) Assignee: Hitachi Industrial Equipment Systems Co., Ltd., Tokyo (JP)

(21) Appl. No.: 18/868,057

(22) PCT Filed: Jun. 2, 2023
(86) PCT No.: PCT/JP2023/020666

§ 371 Date: Nov. 21, 2024

(30) Foreign Application Priority Data
Sep. 12, 2022 (JP) 2022-144926

(51) Int. Cl. H02M 5/458; H02M 1/00; H02M 1/12; H02M 1/14; H02M 7/79

(52) U.S. Cl. CPC H02M 5/458; H02M 1/0009; H02M 1/12; H02M 1/14; H02M 7/79

(57) ABSTRACT

A power regeneration converter is disposed between an inverter outputting a three-phase alternating current (AC) to an electric motor and a three-phase AC power source which is an input system, and supplies induced electric power generated by the motor to the three-phase AC power source, wherein a control unit calculates a three-phase AC voltage target value for performing PWM based on a three-phase AC voltage of the input system detected by an AC voltage detection unit, a three-phase AC detected by an AC detection unit, and a direct current (DC) voltage between the inverter and the power regeneration converter detected by a DC voltage detection unit, and controls the DC voltage between the inverter and the power regeneration converter based on the calculated three-phase AC voltage target value. An output DC voltage is maintained, overmodulation, noise, switching loss, heat generation, and insulation degradation of a load device are decreased.

### TECHNICAL FIELD

The present invention relates to a power regeneration converter, and in particular relates to a power regeneration converter suitable for keeping the output DC voltage at an appropriate value, suppressing heat generation, and preventing deterioration of an electric motor or the like that serves as a load system.

### BACKGROUND TECHNOLOGY

In a power supply system that uses three-phase AC as an input system power supply and supplies power to an electric motor of a load system through a power converter consisting of a converter and an inverter, the electric energy from the electric motor to the inverter may be returned, when the frequency setting is suddenly deceleration, or drive when the actual speed of the electric motor is greater than the output frequency of the inverter. In general, this is called “regeneration” or “power regeneration”.

Normally, the regenerative energy is consumed by replacing it with heat with a regenerative discharge resistor connected to the DC part of the inverter, but the power supply regeneration converter is a device that can reuse the energy that was wasted by returning it to the power supply side.

In such a power supply regeneration converter, in general, control is performed using the DC voltage after conversion from AC to DC as a control command. The control command value of the DC voltage is preferably set so that the PWM modulation performed by the inverter connected to the power supply regeneration converter or the power supply regeneration converter itself with respect to the system side is not overmodulated, the lower limit of this setting is determined by the AC voltage that the entire power converter should output to the load side or the input system side.

In relation to this, Patent Document 1 describes a technique in which a power converter used in a drive system enables variable command of a DC voltage according to the rotational speed of an electric motor as a load, thereby improving operating efficiency.

### PRIOR ART DOCUMENTS

### Patent Literature

Patent Literature 1: JP2014-3746A

### SUMMARY OF THE INVENTION

### Problem to be Solved by the Invention

In a conventional power conversion device with a converter and a inverter function, assuming various operating conditions, the set value of the DC voltage was determined based on the value at which the output AC voltage during regeneration was maximized. With such a DC voltage setting, since a high value voltage is always applied to the lower limit value that changes depending on the rolling state, This may cause the increase in switching loss of both the main elements of the converter and inverter, increase heat generation of filters including reactors, and faster deterioration of insulation of the loaded device.

Therefore, in order to suppress the DC voltage output by the converter, it is conceivable to apply a technique for reducing the load applied to various places by changing the DC voltage as described in Patent Literature 1 to a power supply regeneration converter.

However, since a filter or the like is usually installed between the power supply regeneration converter and the grid power supply, there is a difference between the voltage output by the power supply regeneration converter to the load system side and the input system voltage. Therefore, due to fluctuations in voltage, the DC voltage output by the power supply regeneration converter to the inverter side is different from the expected voltage, problems such as overmodulation, increased switching loss, and increased noise arise.

An object of the present invention is, keep the output DC voltage at an appropriate value, and is to provide a power supply regeneration converter reduces that overmodulation, increased noise, increased switching loss, heat generation of the filter including the reactor, and increased insulation deterioration of the loaded device.

### Means to Solve the Problem

The configuration of the power supply regeneration converter of the present invention is, preferably, a power supply regeneration converter that regenerates an induced electricity generated in an electric motor to a three-phase AC power supply, which is arranged between an inverter that outputs three-phase AC to an electric motor and a three-phase AC power supply that is an input system, bidirectional conversion between DC and AC is performed by the conversion unit, and having a filter unit disposed between the conversion unit and the three-phase AC power supply, an AC voltage detection unit that detects a three-phase AC voltage connected to a three-phase AC power supply using an input system and supplied from a three-phase AC power supply, an AC current detector that detects a three-phase AC current flowing in a power supply regeneration converter, a DC voltage detection unit that detects the DC voltage between the power supply regeneration converter and the inverter, a control unit for calculating a three-phase AC voltage target value for performing PWM modulation based on the three-phase AC voltage detected by the AC voltage detection unit, the three-phase AC current detected by the AC current detection unit, and the DC voltage between the power supply regeneration converter and the inverter detected by the DC voltage detection unit, and the control unit controls the DC voltage between the power supply regeneration converter and the inverter based on the calculated three-phase AC voltage target value.

### Effect of the Invention

According to the present invention, keep the output DC voltage at an appropriate value, a power regeneration converter can be provided without providing increase in overmodulation and noise, increase in switching loss, heat generation in filters including reactors, and increase in insulation deterioration of equipment that serves as a load.

### BRIEF DESCRIPTION OF THE DRAWING

FIG. 1 Circuit block diagram of the power conversion device according to the first embodiment.

FIG. 2 Block diagram which shows the detailed function of the control unit.

FIG. 3A Diagram showing the vector relationship between the power supply voltage, the filter drop voltage, and the AC voltage input and output of the converter unit, and the relationship expressed on the dq axis of the AC current (Part 1).

FIG. 3B Diagram showing the vector relationship between the power supply voltage, the filter drop voltage, and the AC voltage input and output of the converter unit, and the relationship expressed on the dq axis of the AC current (Part 2).

FIG. 3C Diagram showing the vector relationship between the power supply voltage, the filter drop voltage, and the AC voltage input and output of the converter unit, and the relationship expressed on the dq axis of the AC current (Part 3).

FIG. 3D Diagram showing the vector relationship between the power supply voltage, the filter drop voltage, and the AC voltage input and output of the converter unit, and the relationship expressed on the dq axis of the AC current (Part 4).

FIG. 3E Diagram showing the vector relationship between the power supply voltage, the filter drop voltage, and the AC voltage input and output of the converter unit, and the relationship expressed on the dq axis of the AC current (Part 5).

FIG. 3F Diagram showing the vector relationship between the power supply voltage, the filter drop voltage, and the AC voltage input and output of the converter unit, and the relationship expressed on the dq axis of the AC current (Part 6).

FIG. 4 Circuit configuration diagram of the power conversion device according to the second embodiment.

FIG. 5 Circuit configuration diagram of the power conversion device according to the third embodiment.

### DESCRIPTION OF EMBODIMENTS

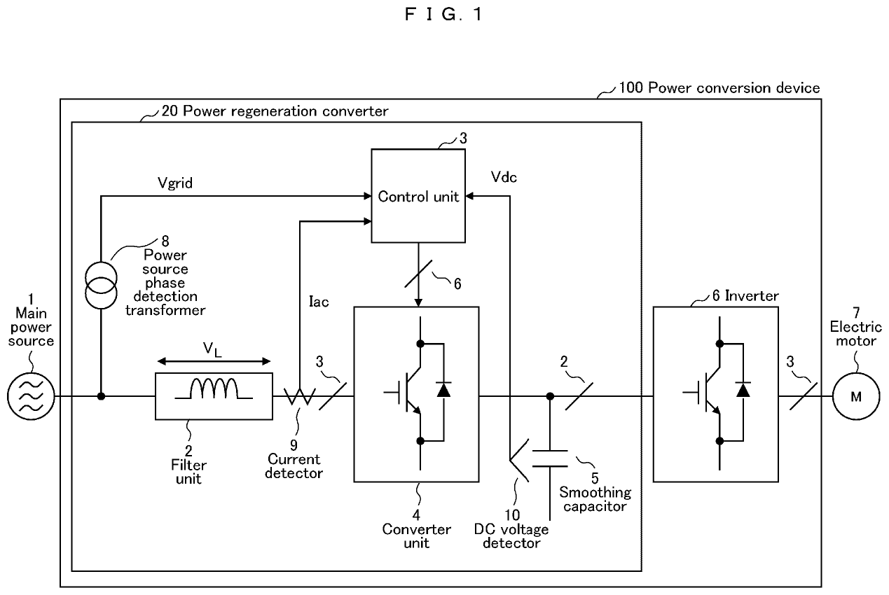

Hereinafter, each embodiment according to the present invention will be described with reference to FIG. 1 to FIG. 5.

### Embodiment 1

Hereinafter, the first embodiment according to the present invention will be described with reference to FIG. 1 to FIG. 3F.

First, the circuit configuration of the power conversion device according to the first embodiment will be described with reference to FIG. 1.

As shown in FIG. 1, the power conversion device 100 according to the first embodiment is connected to an electric motor 7 operating in three-phase AC is connected as a load system with the main power supply 1 of three-phase AC as input, and has a power regeneration converter 20 and an inverter 6.

In the circuit of FIG. 1, the (/n) on the line indicates that n (n is an integer of 1 or more) physical lines.

Power regeneration converter 20 is, at the time of power (in the state of supplying power to the electric motor 7), the input power supply of three-phase AC from the main power supply 1 is converted into DC, and at the time of regeneration (in a state where the electric motor 7 is generating Induce electricity), DC is converted to three-phase AC and power is discharged to the main power supply 1.

The power regeneration converter 20 includes a filter unit 2, a control unit 3, a conversion unit 4, a smoothing capacitor 5, a power source phase detection transformer 8, a current detector 9, and a DC voltage detector 10.

The filter unit 2 is connected to the main power supply 1 to reduce noise. The conversion unit 4 is a circuit that converts AC to DC during force execution and DC to AC during regeneration. The power source phase detection transformer 8 is a transformer for detecting the amplitude and phase of the power supply voltage.

The converter unit 4 is, at the time of power execution, the three-phase AC power supplied from the main power supply 1 is converted into DC power (voltage Vdc) that can be changed, and power is supplied to the inverter 6. Further, during regeneration, the feedback energy from the inverter 6, which is a load, is regenerated to the main power supply 1 by PWM (Pulse Width Modulation) modulation.

The smoothing capacitor 5 is a capacitor element that stores a capacitance for converting AC into DC. The current detector 9 is, between the filter unit 2 and the converter unit 4, a circuit for detecting the AC current Iac between the filter and converter unit. The DC voltage detector 10 is a circuit for detecting the DC voltage Vdc, which is the voltage across both sides of the smoothing capacitor 5.

The converter unit 4 is, for example, consists of six sets of main switching elements in which an IGBT (Insulated Gate Bipolar Transistor) element and a flywheel diode (reflux diode) are connected in parallel. IGBT is a type of power transistor that are characterized by both low saturation voltage and relatively fast switching characteristics. The flywheel diode is a diode for releasing the flyback voltage.

The control unit 3 is a circuit that gives a voltage conversion command to the converter unit. To the control unit 3, the power supply voltage Vgrid through power source phase detection transformer 8, the AC current Iac between the filter unit and converter unit detected from current detector 9, the DC voltage Vdc detected from the DC voltage detector 10 are inputted, and for example, the IGBT element of the converter unit 4 and the flywheel diode are connected in parallel to 6 sets of main switching elements are controlled by PWM control.

Inverter 6 is, at the time of power run, the DC output of the power regeneration converter 20 is converted into three-phase AC supplying to the load system, and at the time of regeneration, the regenerative energy from the electric motor 7 flows to the power regeneration converter 20.

In the above configuration, When the converter unit 4 starts operation and outputs a DC voltage Vdc from both ends of the smoothing capacitor 5, the lower limit value of the DC voltage output varies depending on the operating conditions of the inverter 6 and the electric motor 7. Hereinafter, the reasons for this will be explained.

At the conversion circuits that do not limit the type (“do not limit the type” means that either a converter or an inverter is included), when creating an AC voltage waveform from a DC voltage by PWM modulation, the output AC voltage is adjusted by adjusting the width of the pulse. When the desired AC voltage is obtained by this, even if the same output is performed, adjusting is done, if the DC voltage is high, the pulse width is thinned, and if the DC voltage is low, the pulse width is increased. At this time, if the interval between the pulses cannot be kept above a certain level, overmodulation occurs and accurate output becomes impossible. Therefore, the lower limit of the DC voltage depends on the desired AC output voltage. In the case of the converter unit 4 shown in FIG. 1, specifically, the lower limit value of the DC voltage Vdc to be output depends on the converter unit input/output AC voltage Vac that the conversion unit 4 outputs to the main power source 1 side.

By the way, in the power conversion device 100 as shown in FIG. 1, the conversion unit input/output AC voltage Vac that the conversion unit 4 should output is, for example, when the electric motor 7 is regenerated, a higher AC voltage is required than during power execution. This is the same when the load applied to the electric motor 7 changes, the required torque changes, and the like, in the case of high load, a higher AC voltage is required compared to the case of low load. In this way, the AC voltage required varies depending on the operating conditions such as power and regeneration, and the operating conditions such as the load situation. Therefore, the lower limit of the DC voltage changes according to the operation situation.

The DC voltage Vdc is, for the above reasons, it is difficult to set a constant lower limit value for each individual operation situation, so the DC voltage Vdc is often constant at the maximum DC voltage value in the assumed operating situation.

However, if the DC voltage Vdc is constant, even if a large voltage is not required depending on the operating situation, the output will always be continued at the maximum value.

In the case of driving using a conversion circuit such as, when the DC voltage is high, there are adverse effects and concerns such as an increase in switching loss of the main element, an increase in the calorific value of the filter including the reactor, deterioration of the insulation of the electric motor, and an increase in noise. From these perspectives, the DC voltage Vdc is desirable to keep the output low by setting it to an appropriate variable value together with the AC voltage Vac of the input/output of the converter unit, which changes depending on the operating conditions.

For one example of a control method for changing the DC voltage Vdc, as an AC voltage that the converter should output, is a method of monitoring the voltage of the power source and changing the DC voltage from the three-phase AC value of the power source. [symbol] Applying this technique to the example of the power converter 100 in FIG. 1, as the input amount used by the control unit 3, the power supply voltage Vgrid is used instead of the converter unit input/output AC voltage Vac of the converter unit output to the main power source 1 side, and the output DC voltage Vdc is calculated. However, in the case of the power converter 100 shown in FIG. 1, for example, since a part located between the main power source 1 and the converter unit 4, such as the filter unit 2, is essential, there is a difference between the power source voltage Vgrid and the input/output AC voltage Vac of the converter unit originally required for calculation by the amount of the filter drop voltage VL consumed by the filter unit 2. In the control unit 3 of the present embodiment, this difference is eliminated and the converter unit input/output AC voltage Vac that is truly required is calculated.

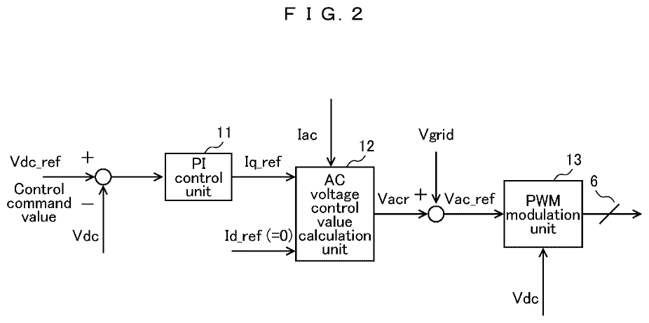

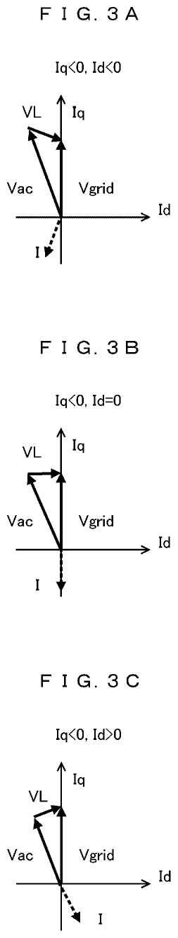

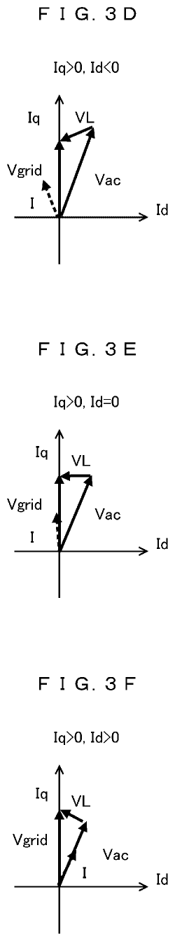

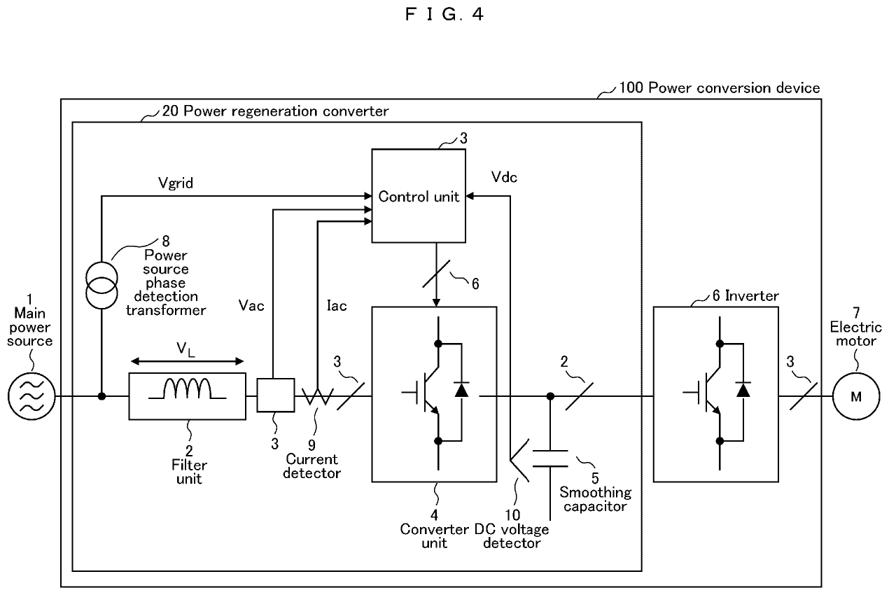

Hereinafter, the operation of the control unit will be described with reference to FIG. 2 to FIG. 3F.

The control unit 3 includes a PI control unit 11, an AC voltage control value calculation unit 12, and a PWM modulation unit 13.

The PI control unit 11 is, calculate difference the difference between the DC voltage control command value Vdc_ref and the DC voltage Vdc actually detected from the DC voltage detector 10 with a subtractor, and the target value Iq_ref of the q-axis current is calculated from the difference.

The AC voltage control value calculation unit 12 is, calculate the AC voltage control value Vacr in the dq-axis coordinate system from the target value of the q-axis current Iq_ref, the separately given target value of the d-axis current Id_ref, and the information of the AC current Iac between the filter unit and converter unit detected by the current detector 9. Here, the target value of the d-axis current Id_ref=0.

The d-axis and q-axis are the coordinate axes in the d-q rotational coordinate system, which is a unique coordinate system used in the field of electric motors and generators, it is a coordinate axis that rotates in synchronization with the rotating magnetic field generated by three-phase AC and the rotor (rotor).

The control unit 3 calculate the command value Vac_ref of the AC voltage output from the converter unit 4 from the AC voltage control value Vacr and the power source voltage Vgrid detected from the power surce phase detection transformer 8, the PWM modulation unit 13 perform PWM control so that the AC voltage output Vac approaches the Vac_ref of the command value based on the command value Vac_ref.

The power source voltage Vgrid is a value that is detected by the power source phase detection transformer 8 and maintains the voltage instantaneous value of each phase of the three phases in the power source voltage, and is input to the control unit 3. This power source voltage Vgrid is expressed as the values Vd and Vq on the dq coordinate system by dq transformation.

Further, the AC current Iac between the filter unit and the converter unit detected by the current detector 9 is a value that maintains the current instantaneous value of each phase of the three phases between the filter unit 2 and the converter unit 4, it is expressed as the reactive current Id and the active current Iq on the DC coordinate system by dq conversion using the voltage phase θ. These reactive current Id, active current Iq, and q-axis current target values Iq_ref, and d-axis current target value Id_ref are input to the AC voltage control value calculation unit 12.

The AC voltage control value calculation unit 12 obtain the voltage command vd for the d-axis and the voltage command vq for the q-axis by comparing the command value and the detection value each dq axis, and calculating the difference proportionally integral (PI) after adding the filter drop voltage VL of the filter unit 2 as a filter compensation term.

The control unit 3 obtain the output voltage command value Vd_ref of the d-axis and the Vq_ref of the q-axis, by adding Vd, which is the value of the d-axis of the power source voltage Vgrid, and Vq, which is the value of the q axis of the power source voltage Vgrid, to the voltage command vd of the d axis and the voltage command vq of the q axis respectively calculated by the AC voltage control value calculation unit 12. By inverse dq conversion, a three-phase instantaneous AC voltage command value Vac_ref is obtained. By inputting this instantaneous AC voltage command value Vac_ref to the PWM modulation unit 13 and comparing it with the carrier wave, six PWM switching signals are obtained.

The instantaneous AC voltage command value Vac_ref is the AC voltage calculated value that the converter outputs to the main power source 1 side. Since the value of the AC voltage command value Vac_ref is the control command value of the AC voltage Vac input and output of the converter unit, the input/output AC voltage Vac of the converter unit becomes a value that asymptotically asymptotes to the instantaneous AC voltage command value Vac_ref.

By the way, the relationship between the input/output AC voltage Vac of the converter unit, the power source voltage Vgrid, and the filter drop voltage VL of the filter unit 2 is expressed by the following (Equation 1).

$$Vgrid = Vac + VL \qquad ( Equation 1 )$$

The relationship expressed by Equation 1 can be graphically represented by the graphs shown in FIG. 3A to FIG. 3F, separately from the positive and negative of the active current Id and the reactive current Iq. In the figure, I=(Id, Iq) is used as a vector representation. Assuming that the power source voltage Vgrid is constant, the vectors of the converter unit input/output AC voltage Vac and the filter drop voltage VL expressed on the dq axis change according to the relationship between the active current Id and the reactive current Iq.

For example, with the relationship shown in FIG. 3A to FIG. 3F, the AC voltage Vac to be output is variable, and the lower limit value of the DC voltage Vdc to be output is also variable.

In the conventional art method, for example, to obtain the value of the DC voltage control command value Vdc_ref, it is calculated by the following (Equation 2) using the constant k.

$$Vdc\_ref = Vgrid \times k \qquad ( Equation 2 )$$

Considering (Equation 2) as an example of FIG. 3A and FIG. 3C, the actual required Vdc_ref are different because the output Vac values are different, but since Vgrid is constant, the Vdc_ref value is the same value in both FIG. 3A and FIG. 3C. For this reason, the conventional method of calculating the DC voltage control command value Vdc_ref according to (Equation 2) cannot follow the change in Vac, and an error occurs in the Vdc_ref of the DC voltage command value.

Therefore, as in the present embodiment, in order to calculate the DC voltage reference value Vdc_ref, in the control unit 3, the instantaneous AC voltage command value Vac_ref input to the PWM modulation unit 13 is used for calculation instead of Vgrid, and a constant k is used, the DC voltage command value Vdc_ref can be expressed by the following (Equation 3).

$$Vdc\_ref = Vac\_ref \times k \qquad ( Equation 3 )$$

Since the instantaneous AC voltage command value Vac_ref in (Equation 3) is a calculated value of the converter unit input/output AC voltage Vac, it becomes a reference value for the converter unit input/output AC voltage Vac. Therefore, the changes in the values of the active current Iq and the reactive current Id shown in FIG. 3A to FIG. 3F are followed in the same way as when Vac is measured and calculated using a measuring instrument, and The DC voltage command value can be input to the DC voltage command value Vdc_ref the amount necessary for the converter outputs the AC current.

As described above, the present embodiment is, connected to AC power source, a regeneration converter capable of bidirectionally converting AC power to DC power and DC power to AC power, the regeneration converter controls the output AC voltage based on the difference between the detection value of the grid power source voltage, the detection value of the DC voltage part, the detection value of the AC current, and the command voltage, and execute a DC voltage command proportional to the AC voltage calculate value calculated in the control process.

As a result, the value of the DC voltage for outputting the AC voltage can be kept at a value suitable for changes due to the operating conditions, it is possible to reduce the increase of over modulation and noise, the increase in switching loss, the heat generated by the filter including the reactor, and the increase in insulation deterioration of the device that becomes the load.

Moreover, in the case of the power conversion device constructed with the power conversion device in the present embodiment, it is not necessary to add a new signal.

### Embodiment 2

Hereinafter, the second embodiment according to the present invention will be described with reference to FIG. 4.

FIG. 4 is a circuit configuration diagram of the power conversion device according to the second embodiment.

The configuration and function of the power conversion device of the present embodiment are substantially the same as the power conversion device 100 of the first embodiment shown in FIG. 1, as shown in FIG. 4, the converter unit input/output AC voltage detector 30 is added between the filter unit 2 and the converter unit 4, it is configured in which the converter unit input/output AC voltage Vac detected by the converter unit input/output AC voltage detector 30 is input.

In the internal calculation, in order to calculate the DC voltage command value Vdc_ref, the converter unit input/output AC voltage Vac is used, and the constant k is used to calculate by the following (Equation 4).

$$Vdc\_ref = Vac \times k \qquad ( Equation 4 )$$

The relationship between the DC voltage Vdc, the command value Vdc_ref, and the subsequent control are the same as in the first embodiment.

### Embodiment 3

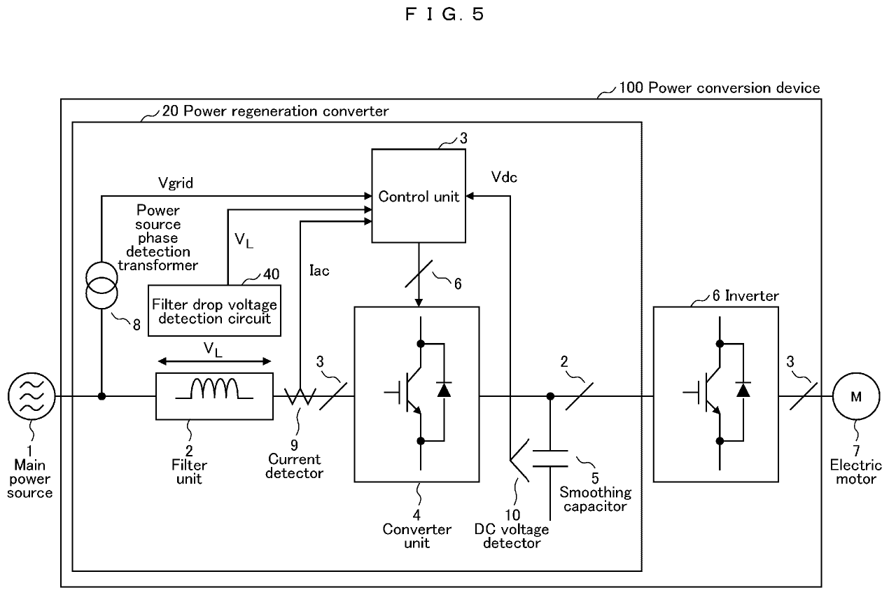

Hereinafter, the third embodiment according to the present invention will be described with reference to FIG. 5.

FIG. 5 is a circuit configuration diagram of the power conversion device according to the third embodiment.

The configuration and function of the power conversion device of the present embodiment are substantially the same as the power conversion device 100 of the first embodiment shown in FIG. 1, as shown in FIG. 5, a filter drop voltage detection circuit 40 is attached to the filter unit 2, and a filter drop voltage VL is input.

By using the filter drop voltage VL, the power source voltage Vgrid, and the AC current value Iac, the AC voltage value Vac output by the converter is calculated, and the DC voltage Vdc_ref to be output is calculated from that value.

The subsequent handling of the command value Vdc_ref is the same as in the first embodiment.

### EXPLANATION OF THE SIGN

1. . . . Main power source
2. . . . Filter unit
3. . . . Control unit
4. . . . Converter unit
5. . . . Smoothing capacitor
6. . . . Inverter
7. . . . Electric motor
8. . . . Power source phase detection transformer
9. . . . Current detector
10. . . . DC voltage detector
11. . . . PI control unit
12. . . . AC voltage control value calculation unit,
13. . . . PWM modulation unit
20. . . . Power regeneration converter
30. . . . Converter unit input/output alternating current voltage detector
40. . . . Filter drop voltage detection circuit
100. . . . Power conversion device

1. A power regeneration converter that is disposed between an inverter that outputs three-phase AC to an electric motor and a three-phase AC power supply using as input system, performs bidirectional conversion between DC and AC by a conversion unit, and regenerates the induced electromotive force generated in the electric motor to the three-phase AC power supply, comprising:
a filter unit disposed between the conversion unit and the three-phase AC power supply;
an AC voltage detection unit that is connected to the three-phase AC power supply as an input system and detects a three-phase AC voltage supplied from the three-phase AC power supply, and
an AC current detection unit that detects a three-phase AC current flowing between the filter and the conversion unit;
a DC voltage detection unit that detects a DC voltage between the power regeneration converter and the inverter;
a control unit for calculating a three-phase AC voltage target value for performing the PWM modulation, based on the three-phase AC voltage detected by the AC voltage detection unit, the three-phase current detected by the AC current detection unit, and the DC voltage between the power regeneration converter and the inverter detected by the DC voltage detection unit; and
the control unit controls the DC voltage between the power regeneration converter and the inverter based on the calculated three-phase AC voltage target value.

2. The power regeneration converter according to claim 1, wherein the DC voltage target value between the power regeneration converter and the inverter is a constant multiple of the three-phase AC voltage target value.

3. A power regeneration converter that is disposed between an inverter that outputs three-phase AC to an electric motor and a three-phase AC power supply using as input system, performs bidirectional conversion between DC and AC by a conversion unit, and regenerates the induced electromotive force generated in the electric motor to the three-phase AC power supply, comprising:
a filter unit disposed between the conversion unit and the three-phase AC power supply;
an AC voltage detection unit that detects a three-phase AC voltage output by the power regeneration converter;
an alternating current detection unit that detects a three-phase AC current flowing between the conversion units;
a control unit for calculating a three-phase AC voltage target value for performing the PWM modulation, based on the DC voltage detection unit that detects the DC voltage between the power regeneration converter and the inverter, the three-phase AC voltage detected by the AC voltage detection unit, the three-phase AC current detected by the AC current detection unit, and the DC voltage between the power regeneration converter and the inverter detected by the DC voltage detection unit; and
as a DC voltage target value input to the control unit, a DC voltage target value between the power regeneration converter and the inverter is calculated based on the AC voltage value detected from the AC voltage detection unit.

4. A power regeneration converter that is disposed between an inverter that outputs three-phase AC to an electric motor and a three-phase AC power supply using as input system, performs bidirectional conversion between DC and AC by a conversion unit, and regenerates the induced electromotive force generated in the electric motor to the three-phase AC power supply, comprising:
a filter unit disposed between the conversion unit and the three-phase AC power supply;
a filter drop voltage detection circuit that detects a voltage drop in the filter portion;
an AC voltage detection unit that detects a three-phase AC voltage connected to the three-phase AC power supply and supplied from the three-phase AC power supply as the input system;
an alternating current detection unit that detects a three-phase AC current flowing between the filter and the conversion unit;
a DC voltage detection unit that detects a DC voltage between the power regeneration converter and the inverter;
a control unit for calculating a three-phase AC voltage target value for performing the PWM modulation, based on the three-phase AC voltage detected by the AC voltage detection unit, the three-phase AC current detected by the AC current detection unit, and the DC voltage between the power regeneration converter and the inverter detected by the DC voltage detection unit; and
as an DC voltage target value input to the control unit, the DC voltage between the power regeneration converter and the inverter is calculated based on the voltage drop detected from the filter drop voltage detection circuit, the power supply voltage detected from the AC voltage detection unit, and the alternating current detected from the AC current detection unit, [symbol]
